(19) United States
(12) Patent Application Publication
(10) Pub. No.: US 2021/0230435 A1
(43) Pub. Date: Jul. 29, 2021

(54) METHOD FOR PREPARING SILVER NANOPARTICLES STABILIZED WITH TETRAOCTYLAMMONIUM, AND METHOD FOR PRODUCING ELECTRICALLY CONDUCTIVE THIN FILM BY USING SILVER NANOPARTICLES PREPARED BY SAME

(71) Applicant: KOREA UNIVERSITY RESEARCH AND BUSINESS FOUNDATION, Seoul (KR)

(72) Inventors: Jinhan CHO, Seoul (KR); Donghee KIM, Seoul (KR); Yongkwon SONG, Seoul (KR)

(73) Assignee: Korea University Research and Business Foundation, Seoul (KR)

(21) Appl. No.: 17/050,906

(22) PCT Filed: Apr. 30, 2019
(86) PCT No.: PCT/KR2019/005210

§ 371 Date: Oct. 27, 2020

(30) Foreign Application Priority Data
Apr. 30, 2018 (KR) 10-2018-0049983
Nov. 26, 2018 (KR) 10-2018-0147149

(51) Int. Cl. C09D 5/24; C09D 7/20; C09D 7/40; C09D 5/00; C09D 179/02; H01B 1/22; B22F 9/24; B22F 1/00

(52) U.S. Cl. CPC C09D 5/24; C09D 7/20; C09D 7/67; C09D 5/002; C08K 2003/0806; H01B 1/22; B22F 9/24; B22F 1/0018; C09D 179/02

(57) ABSTRACT

The present invention relates to a method for preparing silver nanoparticles and a method for producing an electrically conductive thin film by using the silver nanoparticles prepared by same, and provides a method which prepares hydrophobic silver nanoparticles having high distribution stability by being stabilized with tetraoctylammonium by processing with a thiosulfate salt, and which easily produces a thin film having high electrical conductivity, only by processing with a solution without post-processing under a high-temperature high-pressure condition, by using the hydrophobic silver nanoparticles stabilized with tetraoctylammonium.

### TECHNICAL FIELD

The present invention relates to a method for preparing tetraoctylammonium-stabilized silver nanoparticles and a method for producing an electrically conductive thin film using silver nanoparticles prepared by the preparation method.

### BACKGROUND ART

Silver (Ag) is one of the representative precious metals. Silver has great industrial applicability because over 70% of the global silver production is consumed for industrial use. Silver has high electrical conductivity as well as catalytic, antibacterial, and deodorizing activities. Due to these advantages of silver, silver nanoparticles are widely used in a variety of applications such as organic catalysts, optical sensors, binding materials for various electronic devices, and conductive coatings.

Silver nanoparticles are prepared by chemical synthesis and mechanical methods. Since a mechanical method for preparing silver nanoparticles involves mechanical grinding, there is a very high possibility that impurities may be incorporated during processing and there is a disadvantage in that uniform nano-sized particles are not readily prepared. A chemical synthesis method for preparing silver nanoparticles uses a silver precursor and is based on a gas-phase or liquid-phase reduction process. The gas-phase reduction process necessitates expensive equipment. The liquid-phase reduction process has the advantages that uniform nanoparticles of various sizes can be relatively easily prepared in high yield at relatively low cost through control over reaction time and temperature. For these reasons, the liquid-phase reduction process is used in preference to the gas-phase reduction process. The use of the liquid-phase reduction process enables the synthesis of both hydrophilic and hydrophobic nanoparticles, particularly hydrophobic nanoparticles with higher crystallinity and more uniform size.

Long carbon-chain stabilizers having terminal amine or thiol groups are usually used to synthesize hydrophobic silver nanoparticles. Particularly, the use of the stabilizer having thiol groups can ensure high dispersion stability of nanoparticles in a solution but very strong binding between the thiol groups of the stabilizer and the surface of the silver nanoparticles may deteriorate the functions of the silver nanoparticles required for catalytic and biological applications. On the other hand, studies on the use of tetraoctylammonium having a relatively low bonding strength to the metal surface of gold nanoparticles as a stabilizer have been reported but the application of the stabilizer to the synthesis of silver nanoparticles has never been, to our knowledge, reported before. Under these circumstances, there is a need to develop a novel method for synthesizing silver nanoparticles using a stabilizer that can maintain high dispersion stability of the particles while possessing weak binding to the surface of the particles to allow the nanoparticles to exhibit their intrinsic characteristics.

A technique for coating a conductive polymer or carbon nanomaterials on an insulating substrate is used to impart electrical conductivity to the substrate but the conductive polymer or carbon nanomaterials have low electrical conductivity compared to metals in view of their characteristics. Thus, a technique for forming a conductive thin film by coating gold nanoparticles on a substrate has been developed. An electrically conductive thin film using gold nanoparticles can be produced based on low temperature and solution processing and has high electrical conductivity, but the use of expensive gold leads to an increase in production cost. In an effort to solve this problem, research on the use of cheaper silver having higher electrical conductivity than gold has been conducted to achieve high economic efficiency. However, when hydrophobic silver nanoparticles synthesized by the conventional technique are densely packed to form a thin film, their long-chain ligands act as insulating layers, resulting in a reduction in the electrical conductivity of the thin film. For high electrical conductivity of the thin film, annealing is required to remove the ligands. However, annealing cannot be performed for a substrate containing a biosubstance or a substrate made of a highly flexible plastic material having a low glass transition temperature (Tg). Thus, there is an urgent need to develop a method for producing a highly electrically conductive thin film using silver nanoparticles under ambient temperature and pressure conditions without the need for special post-processing.

### DETAILED DESCRIPTION OF THE INVENTION

### Problems to be Solved by the Invention

The present invention has been made in an effort to solve the problems of the prior art and one aspect of the present invention is to provide a method for synthesizing silver nanoparticles stabilized with tetraoctylammonium by treatment with a thiosulfate salt.

A further aspect of the present invention is to provide a method for producing a highly electrically conductive thin film in which silver nanoparticles synthesized by the synthesis method and a monomolecular material having amine groups are alternately stacked on a substrate by layer-by-layer self-assembly such that fusion of the silver nanoparticles is induced under ambient temperature and pressure conditions.

### Means for Solving the Problems

A method for preparing silver nanoparticles according to one embodiment of the present invention includes (a) mixing a solution of tetraoctylammonium bromide (TOABr) in a non-polar solvent with a solution of a silver precursor in a polar solvent to prepare a mixture, (b) adding a thiosulfate salt to the mixture such that silver-thiosulfate anions ([Ag(S₂O₃)₂]³⁻) are phase transferred to the non-polar solvent layer, and (c) separating the non-polar solvent layer containing the phase-transferred silver-thiosulfate anions and adding a reducing agent thereto.

In step (b), the silver-thiosulfate anions ([Ag(S₂O₃)₂]³⁻) may be formed by anion substitution of bromide ions (Br⁻) by thiosulfate ions [(S₂O₃)₂]³⁻ and may be phase transferred to the non-polar solvent layer.

The non-polar solvent may be selected from the group consisting of benzene, hexane, toluene, carbon disulfide (CS₂), carbon tetrachloride (CCl₄), chloroform (CHCl₃), dichloromethane (CH₂Cl₂), octadecene, and mixtures thereof.

The silver precursor may be selected from the group consisting of silver nitrate (AgNO₃), silver perchlorate (AlClO₄), silver chlorate (AgClO₃), silver carbonate (Ag₂CO₃), silver sulfate (Ag₂SO₄), silver chloride (AgCl), silver bromide (AgBr), silver fluoride (AgF), and mixtures thereof.

The polar solvent may be selected from the group consisting of water, alcohol, and mixtures thereof.

The thiosulfate salt may be selected from the group consisting of sodium thiosulfate, ammonium thiosulfate, silver thiosulfate, potassium thiosulfate, and mixtures thereof.

The reducing agent may be selected from the group consisting of sodium borohydride, hydrazine, ascorbic acid, sodium ascorbate, and mixtures thereof.

A method for producing an electrically conductive thin film according to a further embodiment of the present invention includes (a) mixing a solution of tetraoctylammonium bromide (TOABr) in a non-polar solvent with a solution of a silver precursor in a polar solvent to prepare a mixture, (b) adding a thiosulfate salt to the mixture such that silver-thiosulfate anions ([Ag(S₂O₃)₂]³⁻) are phase transferred to the non-polar solvent layer, (c) separating the non-polar solvent layer containing the phase-transferred silver-thiosulfate anions and adding a reducing agent thereto to synthesize silver nanoparticles, (d) immersing a substrate in the dispersion of the silver nanoparticles in the non-polar solvent to form a particle layer on the substrate, and (e) immersing the substrate formed with the particle layer in a dispersion of a monomolecular material having amine groups in an organic solvent to form a linker layer on the particle layer.

The organic solvent may be ethanol.

The method may further include sequentially repeating steps (d) and (e) a plurality of times.

The monomolecular material may be tris(2-aminoethylamine) (TREN).

The method may further include immersing the substrate in a dispersion of polyethylenimine (PEI) to form a base layer on the substrate before step (d).

The substrate may be a silicon or glass substrate and the method may further include immersing the substrate in an RCA solution to form a base layer on the substrate before step (d).

The features and advantages of the present invention will become apparent from the following description with reference to the accompanying drawings.

Prior to the detailed description of the invention, it should be understood that the terms and words used in the specification and the claims are not to be construed as having common and dictionary meanings but are construed as having meanings and concepts corresponding to the technical spirit of the present invention in view of the principle that the inventor can define properly the concept of the terms and words in order to describe his/her invention with the best method.

### Effects of the Invention

According to the present invention, stabilization of hydrophobic silver nanoparticles with tetraoctylammonium by treatment with a thiosulfate salt ensures high dispersion stability of the silver nanoparticles.

In addition, the use of hydrophobic silver nanoparticles stabilized with tetraoctylammonium having a low bonding strength to the surface of the particles facilitates the production of a highly electrically conductive thin film by simple solution processing under ambient temperature and pressure conditions without the need for post-processing.

Furthermore, nanoparticles can be stacked on various substrates made of silicon, highly flexible plastics, and paper to form a plurality of layers. Therefore, the present invention can find application in various devices, including electrodes of energy storage systems and wires of circuits.

### BRIEF DESCRIPTION OF THE DRAWINGS

FIG. 1 is a flow diagram showing a method for preparing silver nanoparticles and a method for producing an electrically conductive thin film using silver nanoparticles prepared by the preparation method according to the present invention.

FIG. 2 shows ¹H NMR spectra of a non-polar solvent layer before and after phase transfer by the addition of a thiosulfate salt in Example 1.

FIG. 3 shows an HR-TEM image of silver nanoparticles stabilized with tetraoctylammonium by treatment with a thiosulfate salt (TOAS-Ag NPs) and dispersed in toluene in Example 1.

FIG. 4 is a graph showing the size distribution of TOAS-Ag NPs measured from the HR-TEM image of FIG. 3.

FIG. 5 is an HR-TEM image of silver nanoparticles synthesized in Comparative Example 1.

FIG. 6 is a TEM image of TOAS-Ag NPs synthesized in Example 1, which was taken 5 days after synthesis.

FIG. 7 is a UV absorbance spectrum of TOAS-Ag NPs synthesized in Example 1.

FIG. 8 shows SEM images of electrically conductive thin films produced in Example 2.

FIG. 9 shows the electrical properties of electrically conductive thin films produced in Example 2.

FIG. 10 compares (a) SEM images and (b) sheet resistances of electrically conductive thin films produced in Example 2 and Comparative Example 2.

FIG. 11 shows the bending test results of an electrically conductive thin film produced in Example 2.

### BEST MODE FOR CARRYING OUT THE INVENTION

Other objects, advantages, and novel features of the invention will become more apparent from the following detailed description and preferred embodiments with reference to the appended drawings. In the drawings, the same elements are denoted by the same reference numerals even though they are depicted in different drawings. In the description of the present invention, detailed explanations of related art are omitted when it is deemed that they may unnecessarily obscure the essence of the present invention.

Preferred embodiments of the present invention will now be described in detail with reference to the accompanying drawings.

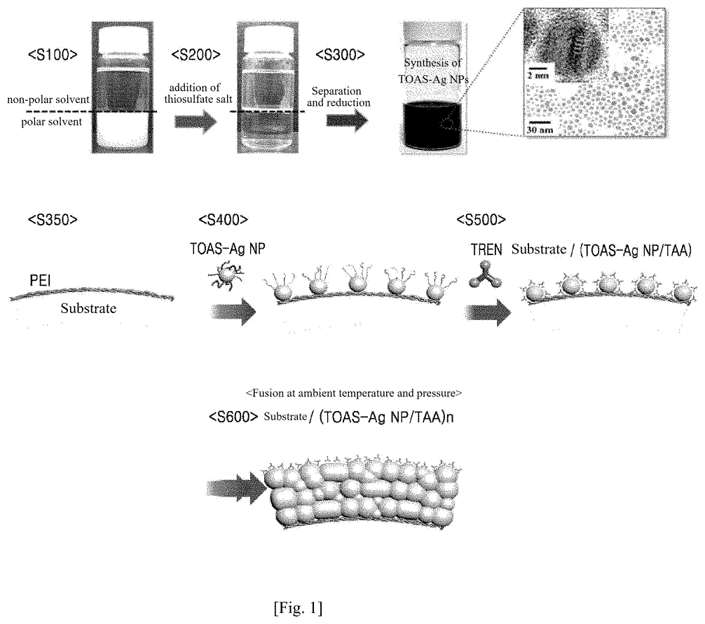

FIG. 1 is a flow diagram showing a method for preparing silver nanoparticles and a method for producing an electrically conductive thin film using silver nanoparticles prepared by the preparation method according to exemplary embodiments of the present invention.

As shown in FIG. 1, a method for preparing silver nanoparticles according to one embodiment of the present invention includes (a) mixing a solution of tetraoctylammonium bromide (TOABr) in a non-polar solvent with a solution of a silver precursor in a polar solvent to prepare a mixture (S100), (b) adding a thiosulfate salt to the mixture such that silver-thiosulfate anions ([Ag(S₂O₃)₂]³⁻) are phase transferred to the non-polar solvent layer (S200), and (c) separating the non-polar solvent layer containing the phase-transferred silver-thiosulfate anions and adding a reducing agent thereto (S300).

That is, the method of the present invention includes the steps of mixture preparation (S10), thiosulfate salt addition (S200), and separation/reduction (S300).

In S100, a solution of tetraoctylammonium bromide (TOABr) in a non-polar solvent is mixed with a solution of a silver (Ag) precursor in a polar solvent to prepare a mixture. The mixture is divided into a non-polar solvent layer containing the TOABr dissolved therein and a polar solvent layer containing the silver precursor dissolved therein. The equivalent ratio of the TOABr to the silver precursor is preferably in the range of 2:1 to 4:1. If the equivalent ratio of the TOABr to the silver precursor is outside the range defined above, the size of the particles may be too large or small and the particles may be relatively non-uniform. The non-polar solvent is not particularly limited so long as the TOABr can be dispersed therein. For example, the non-polar solvent may be selected from the group consisting of benzene, hexane, toluene, carbon disulfide (CS₂), carbon tetrachloride (CCl₄), chloroform (CHCl₃), dichloromethane (CH₂Cl₂), octadecene, and mixtures thereof. The silver precursor may be selected from the group consisting of silver nitrate (AgNO₃), silver perchlorate (AlClO₄), silver chlorate (AgClO₃), silver carbonate (Ag₂CO₃), silver sulfate (Ag₂SO₄), silver chloride (AgCl), silver bromide (AgBr), silver fluoride (AgF), and mixtures thereof. The polar solvent is a solvent capable of dissolving the silver precursor and may be selected from the group consisting of water, alcohol, and mixtures thereof. The alcohol may be selected from the group consisting of propanol, butanol, pentanol, hexanol, and mixtures thereof.

In S200, a thiosulfate salt is added to the mixture such that silver-thiosulfate anions ([Ag(S₂O₃)₂]³⁻) are phase transferred to the non-polar solvent layer. Tetraoctylammonium bromide (TOABr) has not been used as a stabilizer for the synthesis of hydrophobic silver nanoparticles because of the low affinity between TOABr and silver precursor ions (Ag⁺). Thus, a thiosulfate salt is added to the mixture in the present invention. In this case, silver-thiosulfate anions ([Ag(S₂O₃)₂]³⁻) are formed as depicted in the following reaction scheme:

[Reaction scheme]

Ag⁺ (aq)+S₂O₃²⁻ (aq)«Ag(S₂O₃)⁻ (aq) k₁=7.4×10⁸ (1)

Ag(S₂O₃)⁻ (aq)+S₂O₃²⁻ (aq)«[Ag(S₂O₃)₂]³⁻ (aq) k₂=3.9×10⁴ (2)

The anions form complexes with TOA⁺ and the complexes are phase transferred to the non-polar solvent layer. That is, the silver-thiosulfate anions ([Ag(S₂O₃)₂]³⁻) are formed by anion substitution of bromide ions (Br⁻) by thiosulfate ions ([(S₂O₃)₂]³⁻) and are phase transferred to the non-polar solvent layer.

The thiosulfate salt may be selected from the group consisting of sodium thiosulfate, ammonium thiosulfate, silver thiosulfate, potassium thiosulfate, and mixtures thereof.

In S300, the non-polar solvent layer containing the phase-transferred silver-thiosulfate anions is separated and a reducing agent is added thereto to prepare the final hydrophobic silver nanoparticles. For example, the reducing agent may be selected from the group consisting of sodium borohydride, hydrazine, ascorbic acid, sodium ascorbate, and mixtures thereof.

A description will be given of a method for producing an electrically conductive thin film according to a further embodiment of the present invention.

As shown in FIG. 1, the method includes (a) mixing a solution of tetraoctylammonium bromide (TOABr) in a non-polar solvent with a solution of a silver precursor in a polar solvent to prepare a mixture (S100), (b) adding a thiosulfate salt to the mixture such that silver-thiosulfate anions ([Ag(S₂O₃)₂]³⁻) are phase transferred to the non-polar solvent layer (S200), (c) separating the non-polar solvent layer containing the phase-transferred silver-thiosulfate anions and adding a reducing agent thereto to synthesize silver nanoparticles (S300), (d) immersing a substrate in the dispersion of the silver nanoparticles in the non-polar solvent to form a particle layer on the substrate (S400), and (e) immersing the substrate formed with the particle layer in a dispersion of a monomolecular material having amine groups in an organic solvent to form a linker layer on the particle layer (S500).

That is, the method of the present invention includes the steps of mixture preparation (S10), thiosulfate salt addition (S200), separation/reduction (S300), particle layer formation (S400), and linker layer formation (S500). S100, S200, and S300 are the same as those described in the method for synthesizing silver nanoparticles and the following description will be given based on S400 and S500.

In S400, the hydrophobic silver nanoparticles are coated on a substrate to form a particle layer in the form of a thin film. Here, the substrate itself is not electrically conductive and its shape and type are not particularly limited. For example, the substrate may be a silicon substrate, a glass substrate, a highly flexible plastic substrate such as a PET substrate, or a substrate composed of a fiber such as porous paper. The silver nanoparticles can be coated by layer-by-layer self-assembly based on solution processing. For example, the substrate may be immersed in the dispersion of the silver nanoparticles in the non-polar solvent. As a result, the silver nanoparticles are dispersed on the substrate to form a particle layer in the form of a thin film. Toluene is suitable as the non-polar solvent. Alternatively, the non-polar solvent may be a solvent other than toluene. In this case, the non-polar solvent may be selected from the group consisting of benzene, hexane, toluene, carbon disulfide (CS₂), carbon tetrachloride (CCl₄), chloroform (CHCl₃), dichloromethane (CH₂Cl₂), octadecene, and mixtures thereof.

Depending on the type of the substrate, the method may further include (S350) forming a base layer on the substrate before coating of the silver nanoparticles. For example, the substrate may be a silicon substrate, a glass substrate, a plastic substrate or a substrate composed of a fiber such as porous paper that requires the formation of a base layer thereon. The base layer serves to mediate introduction of the particle layer on the substrate. The base layer may be formed by immersing the substrate in a dispersion of a polymer having amine groups such as polyethyleneimine (PEI) in ethanol. When the substate is a planar one without specific surface functional groups, for example, a silicon, glass or plastic substrate, the planar substrate is immersed in an RCA solution or may be treated with UV ozone before formation of a base layer such that its surface is made hydrophilic and is negatively (−) charged. Specifically, when the substrate is a silicon or glass substrate, it is suitable that the substrate is treated with an RCA solution or UV ozone. When the substrate is a plastic substrate, it is suitable that the substrate is treated with UV ozone. The RCA solution may be composed of deionized water, H₂O₂, and 29% ammonia solution (5:1:1). After completion of the RCA solution or UV ozone treatment, a base layer is formed as described above, and the silver nanoparticles are dispersed and stacked on the substrate.

In S500, a monomolecular material having amine groups is coated by layer-by-layer self-assembly to form a linker layer. In the present invention, taking into account the fact that metals have low resistance but films composed of metal particles surrounded by long ligands have insulation properties, a monomolecular material having amine groups is coated on the particle layer to completely replace the insulating ligands. This replacement improves the bonding strength of the silver nanoparticles and increases the electrical conductivity of the particle layer. The amine group-containing monomolecular material serves to improve the electrical conductivity of the particle layer or impart electrical conductivity to the particle layer while immobilizing the silver nanoparticles. The monomolecular material may be, for example, tris(2-aminoethylamine) (TREN). The linker layer is also formed by layer-by-layer self-assembly. Specifically, the linker layer may be formed by immersing the substrate formed with the particle layer in a dispersion of the monomolecular material having amine groups in an organic solvent. The organic solvent is not particularly limited so long as it can disperse the monomolecular material. For example, the organic solvent may be ethanol. Once weakly adsorbed, the monomolecular material may be removed, for example, by washing with ethanol. The substrate having undergone this series of processes is dried to form an electrically conductive bilayer nanocomposite thin film consisting of the nanoparticle layer and the linker layer formed on the nanoparticle layer (see TOAS-Ag NPs/TREN in FIG. 1).

The electrically conductive nanocomposite thin film may have a multilayer structure. To this end, S400 and S500 are sequentially repeated a plurality of (n) times (S600). As a result, an electrically conductive thin film is produced in which n electrically conductive nanocomposite thin films are formed on the substrate.

The n repetitions of S400 and S500 induce fusion of the silver nanoparticles in the multilayer thin film under ambient temperature and pressure conditions. The long-chain insulating tetraoctylammonium ligands having a lower bonding strength to the surface of the silver nanoparticles are completely removed by ligand substitution with the monomolecular material having amine groups, and as a result, the distance between the adjacent silver nanoparticles is minimized by the monomolecular linkers. The minimized distance between the silver nanoparticles and the very low cohesive energy (2.95 eV per Ag atom) of the silver nanoparticles induce fusion of the adjacent silver nanoparticles under ambient temperature and pressure conditions, making the thin film highly electrically conductive (see the substrate/(TOAS-Ag NP/TREN)n in FIG. 1). As used herein, the term “ambient temperature” refers to atmospheric temperature and is approximately 15 to 25° C. However, the ambient temperature is not particularly limited so long as heat is not particularly applied during processing. Likewise, the term “ambient pressure” refers to atmospheric pressure. However, the ambient pressure is not particularly limited so long as pressure is not particularly applied during processing.

Overall, according to the present invention, the use of hydrophobic silver nanoparticles stabilized with tetraoctylammonium having a low bonding strength to the surface of the particles facilitates the production of a highly electrically conductive thin film by simple solution processing under ambient temperature and pressure conditions without the need for post-processing. In addition, nanoparticles can be stacked on various substrates made of silicon, highly flexible plastics, and paper to form a plurality of layers. Therefore, the present invention can find application in various devices, including electrodes of energy storage systems and wires of circuits.

### Mode for Carrying out the Invention

The present invention will be more specifically explained with reference to the following examples.

### EXAMPLE 1

### Synthesis of Silver Nanoparticles Stabilized with Tetraoctylammonium by Treatment with Thiosulfate Salt (TOAS-Ag NPs)

First, a solution of 0.3 mmol of AgNO₃ as a silver precursor in 8 mL of DI water was mixed with a solution of 0.75 mmol of tetraoctylammonium bromide (TOABr) (corresponding to 2.5 equivalents per equivalent of the silver precursor) in 8 mL of toluene in a flask. After stirring at room temperature for 10 min, 1.2 mmol of sodium thiosulfate (Na₂S₂O₃) was added to the reaction mixture. The substitution of bromide ions (Br⁻) by thiosulfate anions ([(S₂O₃)₂]³⁻) formed silver-thiosulfate anions ([Ag(S₂O₃)₂]³⁻). The silver-thiosulfate anions were phase transferred to the toluene layer. The occurrence of phase transfer was confirmed when the opaque solution of the reaction mixture was made transparent. After 10 min, the toluene layer containing the phase-transferred silver-thiosulfate anions was separated. A mixture of 0.45 mmol of sodium borohydride (NaBH₄) as a reducing agent in 8 mL of DI water was mixed with the toluene solution with vigorous stirring for 10 min. By the reducing agent addition and the subsequent stirring, the transparent toluene solution turned dark brown in color, indicating the formation of tetraoctylammonium-stabilized silver nanoparticles (TOAS-Ag NPs). After completion of the reaction, the dark brown TOAS-Ag NPs were separated, washed with DI water, 10 mM HCl, and 10 mM NaOH, and centrifuged at 8,000 rpm for 10 min, making the size of the TOAS-Ag NPs uniform.

### COMPARATIVE EXAMPLE 1

Silver nanoparticles were synthesized in the same manner as in Example 1, except that a solution of 1.5 mmol of tetraoctylammonium bromide (TOABr) (corresponding to 5 equivalents per equivalent of the silver precursor) in 8 mL of toluene.

### EXPERIMENTAL EXAMPLE 1-1

### ¹HNMR Analysis

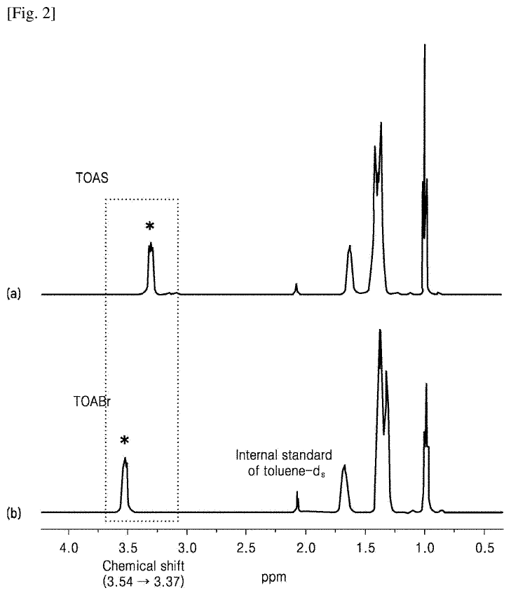

FIG. 2 shows ¹H NMR spectra of the non-polar solvent layer before and after phase transfer by the addition of the thiosulfate salt.

The results of analysis revealed that the protons of the first methyl groups (*) from N⁺ of the tetraoctylammonium molecule were upfield shifted, indicating that the silver-thiosulfate anions ([Ag(S₂O₃)₂]³⁻) formed by anion substitution of the bromide ions (Br⁻) by the thiosulfate ions ([(S₂O₃)₂]³⁻) were phase transferred to the non-polar solvent layer.

### EXPERIMENTAL EXAMPLE 1-2

### Measurement of HR-TEM Images and Size Distribution of the TOAS-Ag NPs

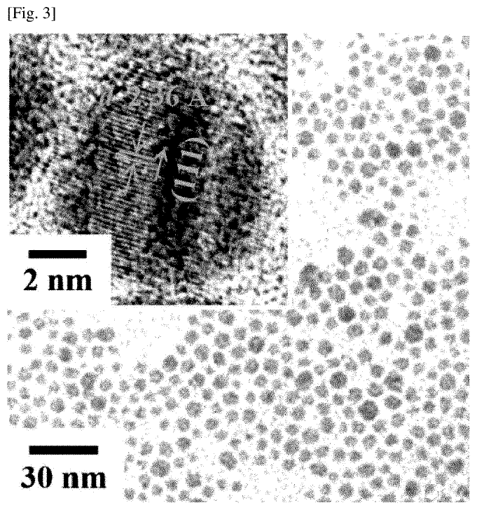

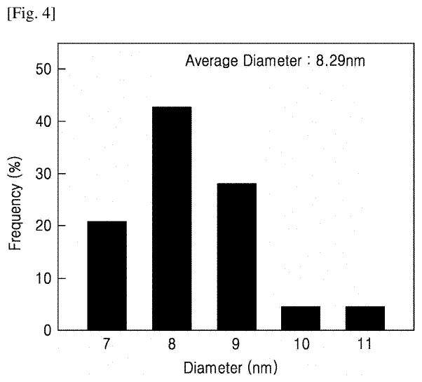

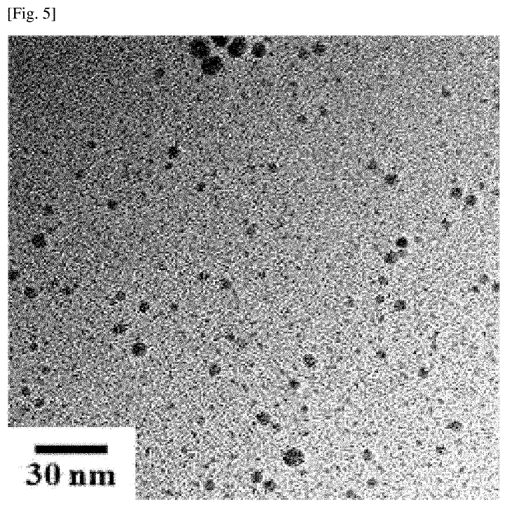

FIG. 3 shows an HR-TEM image of the silver nanoparticles stabilized with tetraoctylammonium by treatment with the thiosulfate salt (TOAS-Ag NPs) and dispersed in toluene in Example 1, FIG. 4 is a graph showing the size distribution of the TOAS-Ag NPs measured from the HR-TEM image of FIG. 3, and FIG. 5 is an HR-TEM image of the silver nanoparticles synthesized in Comparative Example 1.

These results showed that the silver nanoparticles produced using 5 equivalents of TOABr per equivalent of the silver precursor in Comparative Example 1 were relatively uniform in average particle diameter (˜5 nm), whereas the silver nanoparticles produced using 2.5 equivalents of TOABr per equivalent of the silver precursor in Example 1 were uniform in size and spherical in shape and were stably prepared. Specifically, the silver nanoparticles prepared in Example 1 had an average diameter of ˜8.29 nm and a uniform size distribution.

### EXPERIMENTAL EXAMPLE 1-3

### Measurement of Stability of the TOAS-Ag NPs

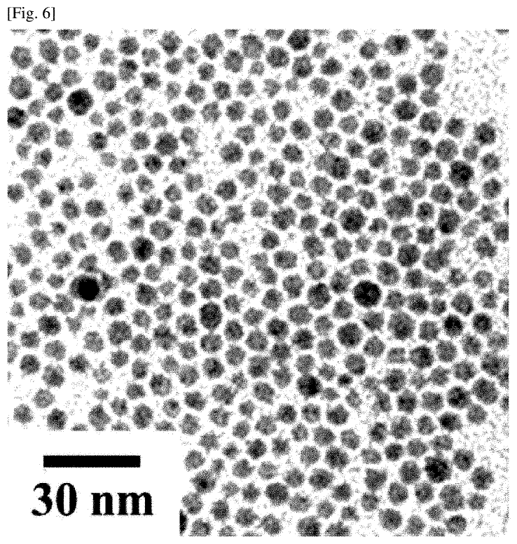

FIG. 6 is a TEM image of the TOAS-Ag NPs synthesized in Example 1, which was taken 5 days after synthesis.

The image showed that the state of the silver nanoparticles stabilized with tetraoctylammonium by treatment with the thiosulfate salt was maintained very stable even 5 days after synthesis due to the stable interaction between the thiosulfate anions ([(S₂O₃)₂]³⁻) and the surface of the silver nanoparticles.

### EXPERIMENTAL EXAMPLE 1-4

### Measurement of UV Absorbance of the TOAS-Ag NPs

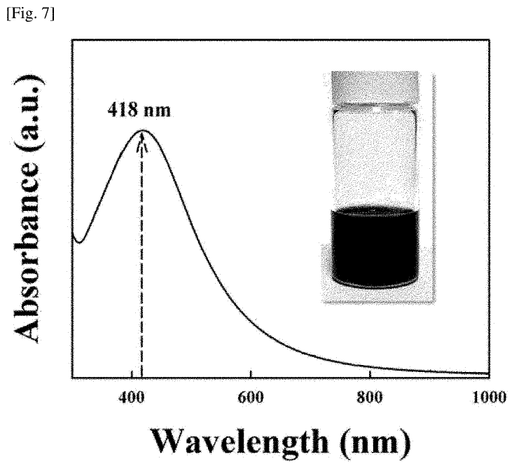

FIG. 7 is a UV absorbance spectrum of the TOAS-Ag NPs synthesized in Example 1.

The spectrum showed a surface plasmon absorption peak observed at 418 nm, demonstrating that the silver nanoparticles were maintained stable without losing the inherent characteristics of previously reported silver nanoparticles.

### EXAMPLE 2

### Production of Electrically Conductive Thin Films

A PET substrate was immersed in a solution of polyethylenimine (PEI) in ethanol (1 mg ml⁻¹) to form a PEI base layer thereon. The PET-coated substrate was washed with ethanol to remove the weakly adsorbed polymer, dried, and immersed in a dispersion of the silver nanoparticles synthesized in Example 1 in toluene (10 mg ml⁻¹) for 60 min to form a particle layer. Likewise, the substrate formed with the particle layer was washed with toluene to remove the weakly adsorbed silver nanoparticles, dried, immersed in a dispersion of TREN in ethanol (1 mg ml⁻¹) to form a linker layer, washed with ethanol to remove the weakly adsorbed TREN molecules, and dried to produce an electrically conductive thin film including one bilayer nanocomposite thin film (substrate/(TOAS-Ag NP/TREN)₁). The steps for forming particle and linker layers were repeated to produce electrically conductive thin films in which 2-20 nanocomposite thin films were formed (substrate/(TOAS-Ag NP/TREN)n (where n=2-20)).

### COMPARATIVE EXAMPLE 2

Electrically conductive thin films were produced in the same manner as in Example 2, except that a zero-generation dendrimer (G0 dend) and a first-generation dendrimer (G1 dend) were used instead of TREN.

### EXPERIMENTAL EXAMPLE 2-1

### Analysis of Morphologies of the Electrically Conductive Thin Films

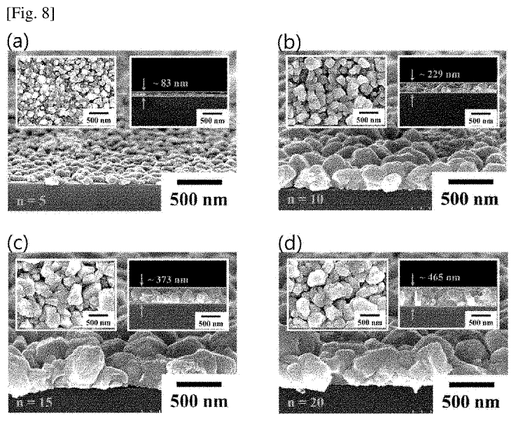

FIG. 8 shows SEM images of the electrically conductive thin films produced in Example 2. Referring to the SEM images, as the number of the nanocomposite thin films increased (n=5, 10, 15, 20), the size of the silver particles increased gradually due to fusion of the silver nanoparticles at ambient temperature and pressure, with the result that continuous networks of the macroparticles were formed. The thickness of the electrically conductive thin film increased linearly with increasing number of the nanocomposite thin films.

### EXPERIMENTAL EXAMPLE 2-2

### Evaluation of Electrical Properties of the Electrically Conductive Thin Films

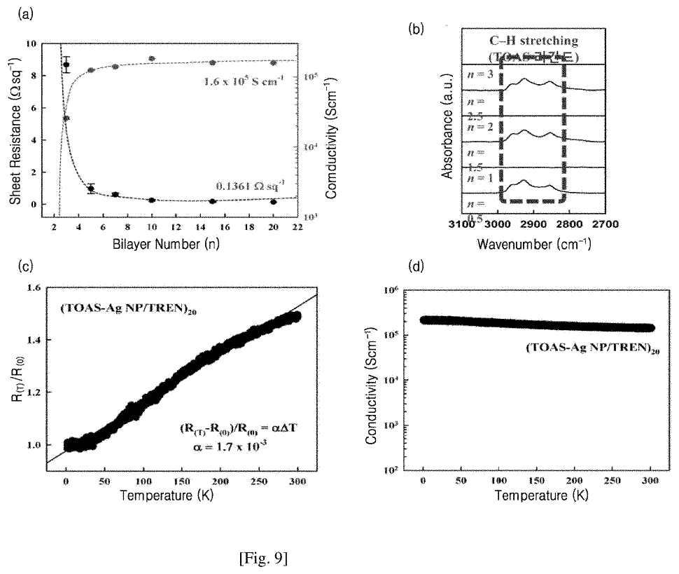

FIG. 9 shows the electrical properties of the electrically conductive thin films produced in Example 2.

Specifically, (a) of FIG. 9 shows the sheet resistances and conductivities of the electrically conductive thin films produced in Example 2 in which the bilayer numbers (n) of the nanocomposite thin films were 3, 5, 7, 10, 15, and 20. The sheet resistance sharply decreased for n≥5, and thereafter, it was maintained at almost the same level. The conductivity was sharply increased for n≥5, and thereafter, it was maintained constant. These results lead to the conclusion that the electrical properties of the electrically conductive thin film can be improved by determining the bilayer number of the nanocomposite thin film.

(b) of FIG. 9 shows Fourier transform infrared (FTIR) spectra of the electrically conductive thin films ((TOAS-Ag NP/TREN)n) produced in Example 2. Here, the n values of 0.5, 1.5, and 2.5 indicate that the particle layers are the outermost layers of the nanocomposite thin films. The C—H stretching peaks of the TOA ligands at 2850-2950 cm⁻¹ were considerably weakened after TREN deposition. From these results, it can be seen that the TOA ligands weakly bound to the surface of the silver nanoparticles were effectively removed when TREN was deposited.

(c) of FIG. 9 is a graph showing the temperature coefficient of the electrically conductive thin film ((TOAS-Ag NP/TREN)₂₀) produced in Example 2 and (d) of FIG. 9 is a graph showing the relationship between temperature and conductivity of the electrically conductive thin film. Analysis of these graphs revealed that the electrical properties of the electrically conductive thin film were similar to those of metals.

### EXPERIMENTAL EXAMPLE 2-3

### Analysis of the Electrically Conductive Thin Films Including Different Numbers of Linker Layers

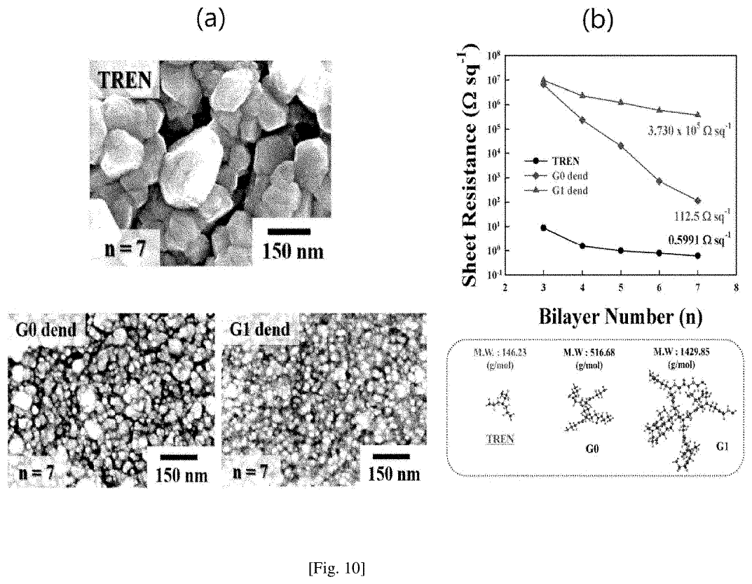

FIG. 10 compares (a) SEM images and (b) sheet resistances of the electrically conductive thin films produced in Example 2 and Comparative Example 2.

When the dendrimers were used, no fusion of the silver nanoparticles occurred. Meanwhile, when the smaller TREN was used as a linker material, fusion of the silver nanoparticles was induced to form a continuous network between the particles. These results indicate that the use of the linker material TREN allows the electrically conductive thin film to have a lower sheet resistance than the use of the dendrimers.

### EXPERIMENTAL EXAMPLE 2-4

### Evaluation of Mechanical Properties of the Electrically Conductive Thin Film

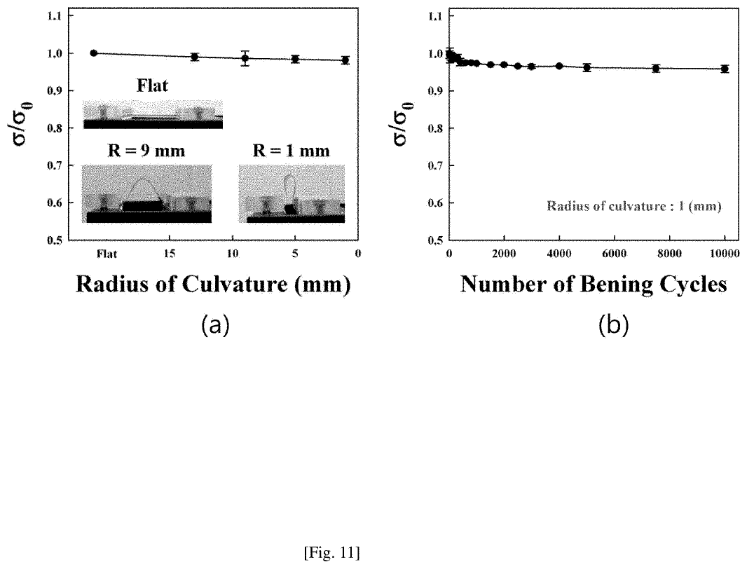

FIG. 11 shows the bending test results of the electrically conductive thin film produced in Example 2. As shown in (a) of FIG. 11, when the radius of curvature was changed, the ratios of the conductivity (σ) after bending to the initial conductivity (σ₀) were maintained almost close to 1. As shown in (b) of FIG. 11, the ratios of the conductivity (σ) after bending to the initial conductivity (σ₀) were almost close to 1 during 10000 bending cycles. These results demonstrate that the electrically conductive thin film has excellent mechanical properties and shows the applicability of the electrically conductive thin film to flexible devices.

Although the present invention has been described herein with reference to the specific embodiments, these embodiments do not serve to limit the invention and are set forth for illustrative purposes. It will be apparent to those skilled in the art that modifications and improvements can be made without departing from the spirit and scope of the invention.

Such simple modifications and improvements of the present invention belong to the scope of the present invention, and the specific scope of the present invention will be clearly defined by the appended claims.

### INDUSTRIAL APPLICABILITY

According to the present invention, stabilization of hydrophobic silver nanoparticles with tetraoctylammonium by treatment with a thiosulfate salt ensures high dispersion stability of the silver nanoparticles. In addition, the use of tetraoctylammonium-stabilized hydrophobic silver nanoparticles facilitates the production of a highly electrically conductive thin film by simple solution processing under ambient temperature and pressure conditions without the need for post-processing. Therefore, the present invention can be recognized as being industrially applicable.

1. A method for preparing silver nanoparticles, comprising (a) mixing a solution of tetraoctylammonium bromide (TOABr) in a non-polar solvent with a solution of a silver precursor in a polar solvent to prepare a mixture, (b) adding a thiosulfate salt to the mixture such that silver-thiosulfate anions ([Ag(S₂O₃)₂]³⁻) are phase transferred to the non-polar solvent layer, and (c) separating the non-polar solvent layer containing the phase-transferred silver-thiosulfate anions and adding a reducing agent thereto.

2. The method according to claim 1, wherein, in step (b), the silver-thiosulfate anions ([Ag(S₂O₃)₂]³⁻) are formed by anion substitution of bromide ions (Br⁻) by thiosulfate ions [(S₂O₃)₂]³⁻ and are phase transferred to the non-polar solvent layer.

3. The method according to claim 1, wherein the non-polar solvent is selected from the group consisting of benzene, hexane, toluene, carbon disulfide (CS₂), carbon tetrachloride (CCl₄), chloroform (CHCl₃), dichloromethane (CH₂Cl₂), octadecene, and mixtures thereof.

4. The method according to claim 1, wherein the silver precursor is selected from the group consisting of silver nitrate (AgNO₃), silver perchlorate (AgClO₄), silver chlorate (AlClO₃), silver carbonate (Ag₂CO₃), silver sulfate (Ag₂SO₄), silver chloride (AgCl), silver bromide (AgBr), silver fluoride (AgF), and mixtures thereof.

5. The method according to claim 1, wherein the polar solvent is selected from the group consisting of water, alcohol, and mixtures thereof.

6. The method according to claim 1, wherein the thiosulfate salt is selected from the group consisting of sodium thiosulfate, ammonium thiosulfate, silver thiosulfate, potassium thiosulfate, and mixtures thereof.

7. The method according to claim 1, wherein the reducing agent is selected from the group consisting of sodium borohydride, hydrazine, ascorbic acid, sodium ascorbate, and mixtures thereof.

8. A method for producing an electrically conductive thin film, comprising (a) mixing a solution of tetraoctylammonium bromide (TOABr) in a non-polar solvent with a solution of a silver precursor in a polar solvent to prepare a mixture, (b) adding a thiosulfate salt to the mixture such that silver-thiosulfate anions ([Ag(S₂O₃)₂]³⁻) are phase transferred to the non-polar solvent layer, (c) separating the non-polar solvent layer containing the phase-transferred silver-thiosulfate anions and adding a reducing agent thereto to synthesize silver nanoparticles, (d) immersing a substrate in the dispersion of the silver nanoparticles in the non-polar solvent to form a particle layer on the substrate, and (e) immersing the substrate formed with the particle layer in a dispersion of a monomolecular material having amine groups in an organic solvent to form a linker layer on the particle layer.

9. The method according to claim 8, wherein the organic solvent is ethanol.

10. The method according to claim 8, further comprising sequentially repeating steps (d) and (e) a plurality of times.

11. The method according to claim 8, wherein the monomolecular material is tris(2-aminoethylamine) (TREN).

12. The method according to claim 8, further comprising immersing the substrate in a dispersion of polyethylenimine (PEI) to form a base layer on the substrate before step (d).

13. The method according to claim 12, further comprising immersing the substrate in an RCA solution or treating the substrate with UV ozone such that the surface of the substrate is negatively (−) charged, before formation of the base layer.
